(19) United States
(12) Patent Application Publication
(10) Pub. No.: US 2004/0252722 A1
(43) Pub. Date: Dec. 16, 2004

(54) Apparatus and method for implementing VLAN bridging and a VPN in a distributed architecture router

(75) Inventors: Jack C. Wybenga, Plano, TX (US); Patricia K. Sturm, Dallas, TX (US)

Correspondence Address: Docket Clerk, P.O. Box 800889, Dallas, TX, 75380, US

(73) Assignee: SAMSUNG ELECTRONICS CO., LTD., Suwon-City (KR)

(21) Appl. No.: 10/460,995

(22) Filed: Jun. 13, 2003

(51) Int. Cl. H04J 3/24

(52) U.S. Cl. 370/474; 370/395.53

(57) ABSTRACT

A router for transmitting data frames to and receiving data frames from N peripheral devices, where the router implements a bridging function between a source peripheral device and a destination peripheral device. The router comprises: i) a first physical medium device (PMD) module for receiving an inbound data frame from the source peripheral device; and ii) a second physical medium device (PMD) module for transmitting an outbound data frame to the destination peripheral device. The first PMD module identifies the second PMD module from a destination address in the inbound data frame and tunnels the inbound data frame through the router to the second PMD module.

### TECHNICAL FIELD OF THE INVENTION

The present invention is directed, in general, to massively parallel routers and, more specifically, to a massively parallel, distributed architecture router that implements virtual local area networking (VLAN) bridging and virtual private networks (VPNs).

### BACKGROUND OF THE INVENTION

A bridge is a network device that connects two or more local area networks (LANs) that use the same protocol (e.g., Ethernet, Token-Ring, etc.). A bridge may also connect two segments of the same LAN. The IEEE 802.1 standard defines the standard features of bridges. A basic bridge has a plurality of ports connected to a plurality of separate LANs. A frame received on one port is re-transmitted on another port. A bridge does not modify the contents of a received data frame.

The bridge described above re-transmits every data frame whether it is necessary or not. A learning bridge examines the source field of every data frame the learning bridge sees on each port and generates a table that defines which addresses are connected to which ports. Thus, if a bridge sees a data frame addressed to a destination that is in its address table, the bridge transmits the data frame only on the port associated with that address, unless the destination address is connected to the same port through which the data frame entered. A bridge will not re-transmit a data frame if the bridge knows that the destination address is connected to the same port on which the bridge saw the data frame. If a bridge sees a data frame addressed to a destination that is not in its address table, the bridge re-transmits the data frame on every port except the one on which the data frame was received.

A router is a device that forwards data frames along networks. A router is connected to at least two networks, commonly two LANs (or WANs) or a LAN and its ISP's network. A router is located at a gateway, the place where two or more networks connect. A router uses headers and forwarding tables to determine the best path for forwarding data frames. Routers use protocols, typically standard routing protocols such as RIP, OSPF, and BGP, to communicate with other routers and configure the best route between any two hosts.

Routing data frames over the Internet relies on three important functions: i) physical address determination; ii) selection of inter-network gateways (or routers); and 3) symbolic to numeric address conversion. Physical address determination is necessary when an IP datagram is to be transmitted from a network device. Physical address determination encapsulates the IP datagram within whatever frame format is in use on the local network (or networks) to which the network device is attached. This encapsulation requires the inclusion of a local network address or physical address within the frame. Selection of a gateway is necessary because the Internet consists of a number of local networks interconnected by one or more gateways. These gateways (or routers) often have physical connections or ports onto many networks. The determination of the appropriate gateway and port for a particular IP datagram is called routing and also involves gateways interchanging information in standard ways. Symbolic to numeric address conversion involves address translation from a form understandable to people to numeric IP addresses. This conversion is performed by the Domain Name System (DNS).

A virtual local area network (VLAN) is a logical broadcast domain overlaid on a physical network. Virtual local area networks use physical network links between multiple groups of users in such a way that it appears to each group of users that they are operating on a private network. Virtual local area networks are specified and differentiated through a Virtual Local Area Network (VLAN) Tag, a four-byte field inserted between the source address field and the protocol type/length field of the Ethernet frame.

A virtual local area network enables different physical local area network (LAN) segments to be connected across a backbone. This enables users on different LANs to share information and to share privileges as if the users reside on the same physical LAN. A requesting device is denied access to a VLAN is unless the requesting device is a member of that particular VLAN. Virtual Private Networks (VPNs) use VLAN technology to allow networks to traverse a public network, while providing the properties of a private leased line network in terms of security and data integrity.

VLAN access privileges may be granted based on many different criteria, such as port number, Ethernet MAC address, protocol type in Ethernet frame, Layer 3 information (such as subnets), and the like. VLAN binding is used to associate a VLAN ID with a port or with frame contents, such as MAC address, protocol, or subnet. A port-based VLAN is static. A port number is associated with a VLAN ID through manual configuration. Typically, a port only belongs to one port-based VLAN and there is a spanning tree instance for each VLAN. A MAC-based VLAN is dynamic, in that a port is assigned to a VLAN after the port receives a frame with a MAC address matching a VLAN criterion. Tables are manually built associating VLAN IDs and MAC addresses.

A MAC-based VLAN allows a workstation to be moved to a different place in the virtual network and retain its VLAN membership. A protocol-based VLAN is a virtual local area network based on the Protocol Type field in the Layer 2 (L2) header. A policy-based VLAN is defined by Layer 3 (L3) information, such as subnets. A table is manually constructed to associate the Layer 3 information (such as subnet) with VLAN IDs. The IEEE 802.1Q-1998 standard also defines a protocol called GARP VLAN Registration Protocol (GVRP) that allows automatic distribution of VLAN information between switches. The acronym “GARP” stands for Generic Attribute Registration Protocol and is defined in the IEEE 802.1D-1998 standard.

There are several different types of links defined by IEEE 802.1Q-1998. Trunk links allow multiplexing of different virtual local area networks. All frames on a trunk link, including end station frames, include the VLAN tag. Access links allow multiplexing of one or more non-VLAN devices to a port. All frames entering or exiting these ports are untagged. The tag is added when the frames enter the switch through the access link ports. Hybrid links support both tagged and untagged frames. On a hybrid link, all frames belonging to a particular VLAN must be either tagged or untagged, but some virtual local area networks can be tagged and others can be untagged. The tagging of frames on the link is a function of the VLAN ID, not a function of the link.

Typically, with access links, the end device does not know about the VLAN. The VLAN tag is added when the frame enters a port and is associated with a VLAN. The VLAN tag is removed when the frame is delivered to the end device. Since the VLAN tag becomes part of the Ethernet frame, the CRC must be recomputed when a VLAN tag is added, removed, or swapped. In addition, the frame length changes by four bytes when a VLAN tag is added and removed, so the frame length field in the Ethernet header must be updated.

A virtual local area network provides algorithms for managing traffic on Ethernet networks. The VLAN tag includes a priority field that allows implementation of a Class of Service (CoS) capability. The IEEE 802.1D-1998 standard specifies the algorithm for forwarding frames according to the traffic class of the frame, but does not define the frame format for frame prioritization. The IEEE 802.3ac and the IEEE 802.1Q-1998 standards define frame prioritization in the Ethernet frame using the Priority field in the VLAN tag. Typically, untagged frames entering the router are given a priority level associated with the port, although more sophisticated prioritization schemes based on frame or frame content are permitted.

The algorithm defined in IEEE 802.1D-1998 specifies that each supported value of traffic class has an associated queue and that frames are transmitted from the highest priority queue containing frames. Each priority queue is depleted before the next lower queue is used. In other words, frames are transmitted from a queue of a given priority only if all queues of higher priority are empty. Higher priority means a lower value in the Priority field of the VLAN tag. The IEEE 802.1D-1998 standard allows support of additional implementation specific algorithms.

A switch may modify the priority of a received frame according to a User Priority Regeneration Table that is manually configured. The class of service algorithms used for VLAN includes Classify, Queue and Schedule (CQS) Algorithms. Priority levels are associated with: 1) queuing and scheduling behaviors; 2) policing and rate shaping; and 3) admission control.

For IEEE 802.1D bridging, data traffic is filtered and forwarded based on what the bridge has learned (i.e., on MAC address associations with ports). Multicast frames are forwarded on all ports. The IEEE 802.1D-1998 standard allows bridges to dynamically modify the filtering database so that multicast traffic is only forwarded to ports that have downstream stations needing the multicast frame. Stations join the IP multicast groups of interest.

It is desirable in many instances to combine the functions of a bridge, particularly a VLAN bridge, into a router. Such a combination device is sometimes called a brouter. A brouter is capable of routing specific types of data frames, such as TCP/IP frames, through a network. For other types of frames, the brouter simply forwards the data frames to other networks connected to the brouter, in the manner of a bridge.

However, the prior art devices which combine router and bridge functions often use a separate Ethernet VLAN switch and router, or provide a VLAN topology that differs from normal Ethernet VLAN topologies. In addition, adding a VLAN bridge capability to a traditional router requires substantial changes to the core routing and forwarding functions. The previous techniques required significant changes to the core routing functions, resulting in difficulty in adding this functionality to an existing router. In addition, the resulting VLAN bridges did not look like traditional Ethernet VLAN topologies.

Therefore, there is a need in the art for an improved Internet protocol (IP) router. In particular, there is a need for a massively parallel, distributed architecture router that is capable of implementing VLAN bridging functionality.

### SUMMARY OF THE INVENTION

The present invention combines VLAN bridge functionality normally found in an Ethernet VLAN bridge into a massively parallel, distributed architecture router. A traditional router cannot look like a normal Ethernet VLAN bridge topology. By placing VLAN bridges at the router interfaces, instead of at the router core, and tunneling frames through the router from interface to interface, the distributed architecture router of the present invention behaves like a traditional VLAN Ethernet bridge.

The router of the present invention uses VLAN bridges on the physical media device (PMD) network processors to make portions of the router act as a conventional Metro Ethernet switch. When the VLAN bridge is installed in a PMD module, then that PMD functions as a virtual Ethernet switch. When a VLAN Bridge is not installed, then the payload must be in Internet Protocol (IP) format and the PMD module acts as a gateway (i.e., router).

The present invention enables a VLAN bridge topology to look just like a traditional Ethernet VLAN bridge. In addition, it places the VLAN functionality at the extremities of the router, allowing a portion of the router (i.e., PMD module) to function as a VLAN bridge without affecting the operation of the rest of the router. Thus, adding VLAN functionality is simple and does not affect the core router architecture or design. Thus, the present invention is simpler, easier to manage, and operates like a conventional Ethernet VLAN bridge.

To address the above-discussed deficiencies of the prior art, it is a primary object of the present invention to provide, for use in a communication network, a router capable of transmitting data frames to and receiving data frames from N peripheral devices, wherein the router is further capable of implementing a bridging function between a source peripheral device and a destination peripheral device. According to an advantageous embodiment of the present invention, the router comprises: i) a first physical medium device (PMD) module capable of receiving an inbound data frame from the source peripheral device; and ii) a second physical medium device (PMD) module capable of transmitting an outbound data frame to the destination peripheral device, wherein the first PMD module identifies the second PMD module from a destination address in the inbound data frame and tunnels the inbound data frame through the router to the second PMD module.

According to one embodiment of the present invention, the second PMD module transmits the inbound data frame to the destination peripheral device as the outbound data frame.

According to another embodiment of the present invention, the first PMD module adds a VLAN tag to the inbound data frame prior to tunneling the inbound data frame and the VLAN tag to the second PMD module.

According to still another embodiment of the present invention, the first PMD module tunnels the inbound data frame to the second PMD module by adding tunneling header information to the inbound data frame.

According to yet another embodiment of the present invention, the first PMD module is capable of determining if the inbound data frame is a non-IP frame and, in response to the determination, the first PMD module is further capable of adding an MPLS label to the tunneling header information.

According to a further embodiment of the present invention, the router further comprises a first input-output processor (IOP) module and a second input-output processor (IOP) module, wherein the first IOP module is capable of receiving the inbound data frame and the tunneling header information from the first PMD module and replacing the tunneling header information with an Ethernet header suitable for transmitting the inbound data frame through an Ethernet switch to the second IOP module.

According to a yet further embodiment of the present invention, the second IOP module is capable of replacing the Ethernet header with the tunneling header information from the forwarding descriptor in the forwarding table and transferring the inbound data frame and the tunneling header information to the second PMD module.

According to a still further embodiment of the present invention, the second PMD module receives the inbound data frame and the tunneling header information from the second IOP module, removes the tunneling header information, and transmits the inbound data frame to the second peripheral device as the outbound data frame.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates a distributed architecture router that implements a distributed forwarding table according to the principles of the present invention;

FIG. 2 illustrates selected portions of an exemplary routing node in the distributed architecture router according to one embodiment of the present invention;

FIG. 3 is a flow diagram illustrating frame format states at various stages in the exemplary distributed architecture router; and

FIG. 4 illustrates in greater detail an IEEE 802.3 SNAP header with VLAN functionality according to the principles of the present invention.

### DETAILED DESCRIPTION OF THE INVENTION

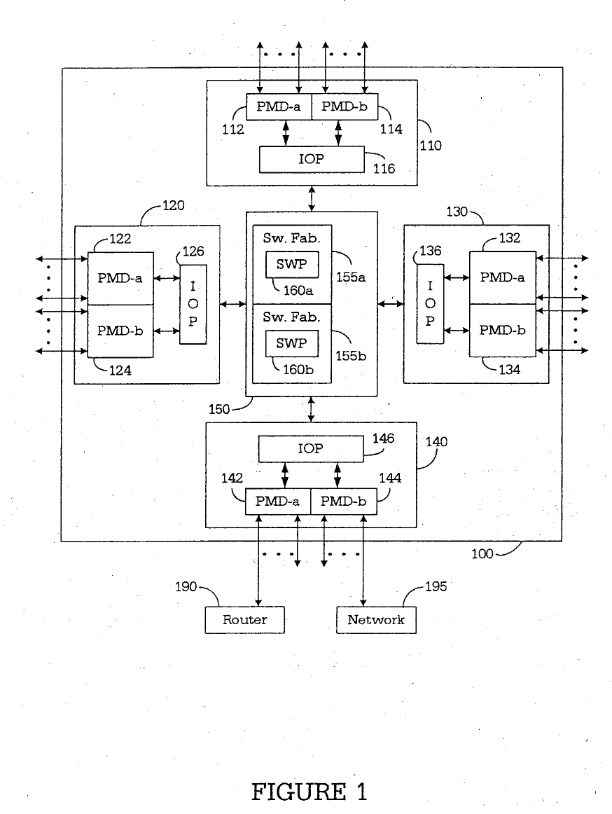

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged distributed router.

FIG. 1 illustrates exemplary distributed architecture router 100, which implements a distributed forwarding table according to the principles of the present invention. Distributed architecture router 100 provides scalability and high-performance using up to N independent routing nodes (RN), including exemplary routing nodes 110, 120, 130 and 140, connected by switch 150, which comprises a pair of high-speed switch fabrics 155a and 155b. Each routing node comprises an input-output processor (IOP) module, and one or more physical medium device (PMD) module. Exemplary RN 110 comprises PMD module 112 (labeled PMD-a), PMD module 114 (labeled PMD-b), and IOP module 116. RN 120 comprises PMD module 122 (labeled PMD-a), PMD module 124 (labeled PMD-b), and IOP module 126. RN 130 comprises PMD module 132 (labeled PMD-a), PMD module 134 (labeled PMD-b), and IOP module 136. Finally, exemplary RN 140 comprises PMD module 142 (labeled PMD-a), PMD module 144 (labeled PMD-b), and IOP module 146.

Each one of IOP module 116, 126, 136 and 146 buffers incoming Internet protocol (IP) frames and MPLS frames from subnets or adjacent routers, such as router 190 and network 195. Additionally, each one of IOP modules 116, 126, 136 and 146 classifies requested services, looks up destination addresses from frame headers, and forwards frames to the outbound IOP module. Moreover, each IOP module also maintains an internal routing table determined from routing protocol frames and provisioned static routes and computes the optimal data paths from the routing table. Each IOP module processes an incoming frame from one of its PMD modules. According to one embodiment of the present invention, is each PMD module frames an incoming frame (or cell) from an IP network (or ATM switch) to be processed in an IOP module and performs bus conversion functions.

Each one of routing nodes 110, 120, 130, and 140, configured with an IOP module and PMD module(s) and linked by switch fabrics 155a and 155b, is essentially equivalent to a router by itself. Thus, distributed architecture router 100 can be considered a set of RN building blocks with high-speed links (i.e., switch fabrics 155a and 155b) connected to each block. Switch fabrics 155a and 155b support frame switching between IOP modules. Switch processors, such as exemplary switch processors (SWP) 160a and 160b, located in switch fabrics 155a and 155b, respectively, support system management.

Unlike a traditional router, distributed architecture router 100 requires an efficient mechanism of monitoring the activity (or “aliveness”) of each routing node 110, 120, 130, and 140. Distributed architecture router 100 implements a routing coordination protocol (called “loosely-coupled unified environment (LUE) protocol”) that enables all of the independent routing nodes to act as a single router by maintaining a consistent link-state database for each routing node. The loosely-unified environment (LUE) protocol is based on the design concept of OSPF (Open Shortest Path First) routing protocol and is executed in parallel by daemons in each one of RN 110, 120, 130, and 140 and in SWP 160a and SWP 160b to distribute and synchronize routing tables. As is well known, a daemon is an agent program which continuously operates on a processing node and which provides resources to client systems. Daemons are background processes used as utility functions.

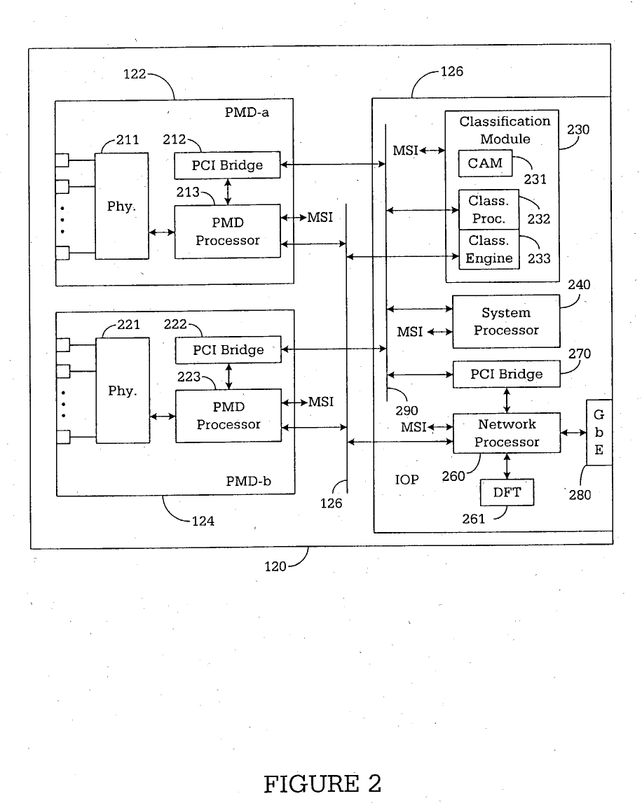

FIG. 2 illustrates selected portions of exemplary routing node 120 in distributed architecture router 100 according to one embodiment of the present invention. Routing node 120 comprises physical medium device (PMD) module 122, physical medium device (PMD) module 124 and input-output processor module 126. PMD module 122 (labeled PMD-a) comprises physical layer circuitry 211, physical medium device (PMD) processor 213 (e.g., IXP 1240 processor), and peripheral component interconnect (PCI) bridge 212. PMD module 124 (labeled PMD-b) comprises physical layer circuitry 221, physical medium device (PMD) processor 223 (e.g., IXP 1240 processor), and peripheral component interconnect (PCI) bridge 222.

IOP module 126 comprises classification module 230, system processor 240 (e.g., MPC 8245 processor), network processor 260 (e.g., IXP 1200 or IXP 1240 processor), peripheral component interconnect (PCI) bridge 270, and Gigabit Ethernet connector 280. Classification module 230 comprises content addressable memory (CAM) 231, classification processor 232 (e.g., MPC 8245 processor), and classification engine 233. Classification engine 233 is a state graph processor. PCI bus 290 connects PCI bridges 212, 222 and 270, classification processor 232, and system processor 240 for control plane data exchange such as route distribution. IX bus 126 interconnects PMD processor 213, PMD processor 223, and network processor 260 for data plane traffic flow. Network processor 260 comprises microengines that perform frame forwarding. Network processor 260 uses distributed forwarding table (DFT) 261 to perform forwarding table lookup operations. The network processor (e.g., network processor 260) in each IOP module (e.g., IOP module 126) performs frame forwarding using a distributed forwarding table (e.g., DFT 261).

According to the principles of the present invention, router 100 implements VLAN bridge functionality normally found in an Ethernet VLAN bridge. This is accomplished by placing the VLAN bridge functionality at the router interfaces (i.e., PMD modules 112, 114, 122, 124, 132, 134, 142, 144), instead of at the router core. The VLAN functionally in the PMD modules tunnels frames through router 100 from interface to interface (i.e., from a first PMD module to a second PMD module). Thus, distributed architecture router 100 is capable of behaving like a traditional VLAN Ethernet bridge.

Router 100 implements VLAN bridge functionality using the PMD processors, such as PMD processors 213 and 223, to thereby make selected components of router 100 act like a conventional Metro Ethernet switch. When the software code for the VLAN bridge functionality is installed in a PMD module, the PMD module functions like a virtual Ethernet switch. When the software code for the VLAN bridge functionality is not installed, then the data frame payload must be in Internet Protocol (IP) format and the PMD module acts as a gateway (i.e., router).

Router 100 implements VLAN and VPN functionality in the PMD processors, such as PMD processors 213 and 223. Router 100 supports port-based, medium access control (MAC) address-based, and policy-based virtual local area networks (VLANs). Protocol based VPNs are supported only in association with MPLS, where protocols other than Internet Protocol (IP) are encapsulated in MPLS frames. Distributed architecture router 100 allows provisioning of VLAN binding tables through the CLI interface. A port can be configured through CLI to use a port-based VLAN, a MAC address-based VLAN, a policy-based VLAN in the form of subnets, or a protocol-based VLAN in association with MPLS ports.

The PMD daemon in each PMD processor (e.g., PMD processors 213, 223) includes a CLI interface (VTYSH Server) that accepts bindings of port-to-VLAN ID for port-based VLANs, MAC address-to-VLAN ID for MAC address-based VLANs, subnet-to-VLAN ID for policy-based VLANs, and protocol type-to-VLAN ID for protocol-based VLANs. Tables are built in each PMD processor from this binding information. According to an exemplary embodiment of the present invention, distributed architecture router 100 supports VLAN distribution through GVRP.

Distributed architecture router 100 supports access links and trunk links. For access links, the VLAN tag is added to the ingress frames and removed from the egress frames. Trunk links have the VLAN tag on all ingress and egress frames. In distributed architecture router 100, VLAN frames are tunneled between the ingress and egress internal routing nodes using MPLS tunnels.

Each PMD processor is provisioned through CLI to either have a VLAN bridge application running or not. If a PMD processor is not configured to be a VLAN bridge, there is no VLAN tagging and the payload must be a conventional IP load. A PMD port and its corresponding VLAN ID are associated with a particular customer. A port on a PMD processor provisioned as a VLAN bridge cannot be enabled until a VLAN ID is assigned to the port.

Ethernet PMD modules have up to 8 physical line side ports and up to 768 virtual ports into the IOP modules. The virtual port identifiers are placed into the Interface Descriptor (IFD) that is placed at the front of the frames transferred over the bus between the PMD modules (e.g., PMD modules 122, 124) and the IOP module (e.g., PMD module 126).

Ingress Processing:

The operation of the present invention shall be explained in terms of an example in which data frames are entering and leaving PMD module 122. When a data frame enters the VLAN bridge in PMD processor 213, PMD processor 213 checks for a VLAN ID. If the frame is untagged, PMD processor 213 attaches a VLAN tag to the frame. If the VLAN is port-based, the VLAN tag for the port is attached. If the VLAN is MAC address-based, policy-based, or protocol-based, PMD processor 213 uses the associated MAC address, IP subnet address, or Protocol Type field as an index into the corresponding provisioned table to get the VLAN ID. Policy-based VLANs can use other fields such as Layer 4 addresses in addition to IP subnet addresses. If the associated field is not in the table, then PMD processor 213 uses the default port VLAN ID. If the frame is tagged, PMD processor 213 compares the frame tag to the provisioned tag of the VLAN bridge and translates the frame tag, if necessary. Thus, within distributed architecture router 100, all frames associated with VLAN bridge ports have VLAN tags.

Next, the VLAN bridge functionality in PMD processor 213 looks up the VLAN tag to get the virtual port. The virtual port is placed into the Sub-Channel field of the IFD. The virtual port may be associated with an IP Subnet for numbered ports or an MPLS tunnel for unnumbered ports. The virtual local area networks of a single customer may be aggregated into MPLS tunnels that serve as a trunk, typically to a distant location.

If the virtual port is associated with an IP Subnet, then PMD processor 213 strips the Ethernet framing and sends the frame to IOP network processor 260 over bus 126. IOP network processor 260 associates the destination IP address with an IP subnet. If it is not in a known subnet, then the frame is dropped. If the virtual port is associated with an MPLS Tunnel, then PMD processor 213 constructs an MPLS Frame containing the frame and sends the MPLS frame to IOP network processor 260 over bus 126.

Broadcast frames entering a port associated with a VLAN are sent only to other ports associated with the same VLAN. IEEE 802.1D-1998 allows formation of multicast groups, thus permitting multicast frames to be forwarded only to ports that have downstream stations that are members of the multicast group. In distributed architecture router 100, broadcast and multicast frames from a specific VLAN are sent only to ports associated with that VLAN. No frames cross VLAN boundaries in distributed architecture router 100.

Ingress processing on each PMD module supports Credit Based Traffic Policing. A rate limit can be associated with each port. During low traffic conditions (i.e., when the traffic load is below the rate limit), credit is built up. During traffic peaks, the credits may be used up. When the credit is exhausted, frames above the rate limit are dropped. Over a long term average, the port is forced to limit traffic to its committed bandwidth.

Typically, encryption is supported on VPNs, since these virtual local area networks transmit data over a public network. Virtual local area networks requiring encryption are tunneled through a Service and Security Module (SSM).

Egress Processing:

The bridge functionality in PMD processor 213 examines the Virtual Port in the IFD of frames entering PMD processor 213 from IOP network processor 260 over bus 126. These frames arrive in the form of an MPLS tunnel. If the port is configured as a Trunk Link, then PMD processor 213 inserts the VLAN ID associated with the virtual port and drops the frame if the port is not a member of that VLAN. If the port is configured as an Access Link, PMD processor 213 examines the VLAN tag associated with the Virtual Port for membership in the VLAN and drops the frame if the port is not a member of the VLAN. For both trunk links and access links, PMD processor 213 removes the IFD and MPLS label and queues the frame for output based on its priority. On hybrid links, the VLAN ID is configured to indicate whether the VLAN ID should be retained or dropped in the outgoing frame.

Distributed architecture router 100 supports Class of Service (CoS) through the priority field in the VLAN Header. As defined in IEEE 802.1D-1998, incoming frames are placed into queues based on priority. The 3-bit priority field is used to place frames into one of eight queues. The lower the value in the priority field, the higher the priority of the frame. Distributed architecture router 100 supports the Class of Service algorithm specified in IEEE 802.1D-1998, namely a strictly Priority scheme wherein the highest priority frames are all output before any lower priority frames are output. IEEE 802.1D-1998 also allows additional implementation-specific algorithms.

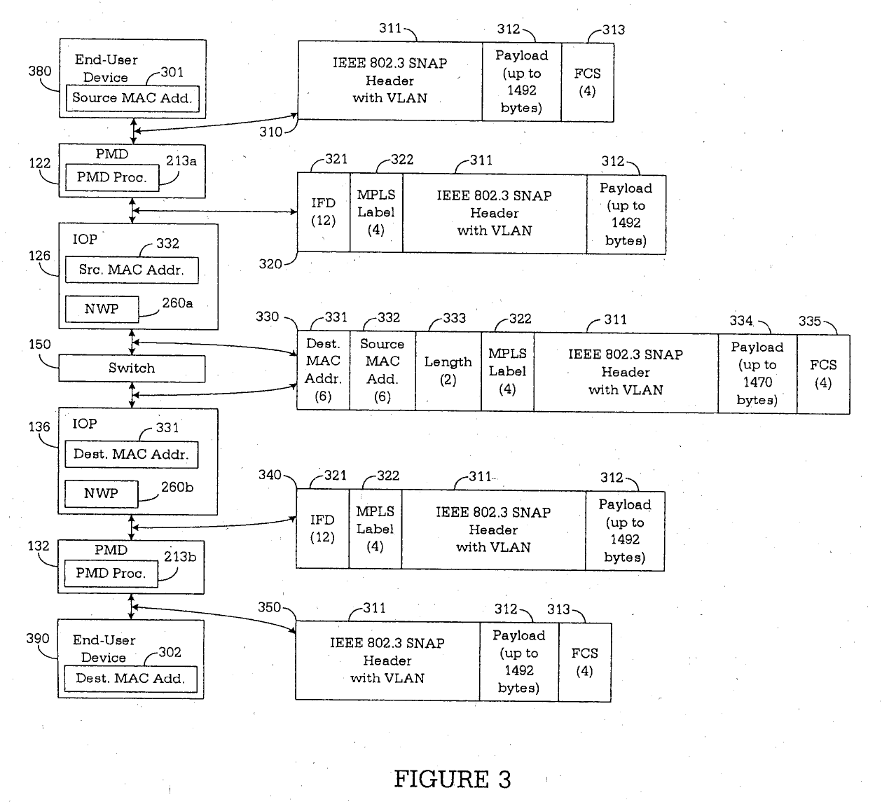

FIG. 3 is a flow diagram illustrating data frame formats at the major interfaces in the exemplary distributed architecture router 100 when VLAN bridging is implemented. Data frames 310, 320, 330, 340 and 350 illustrate the stage-by-stage progress of a representative data frame. As noted above, router 100 supports Layer 2 (L2) Ethernet bridging, including VLAN support. For L2 bridging, the Ethernet header must be retained through router 100, so that the source address and the destination address, as well as the VLAN Tag, remain intact. Non-IP payloads must be tunneled through router 100 using MPLS, so an MPLS Label must be added.

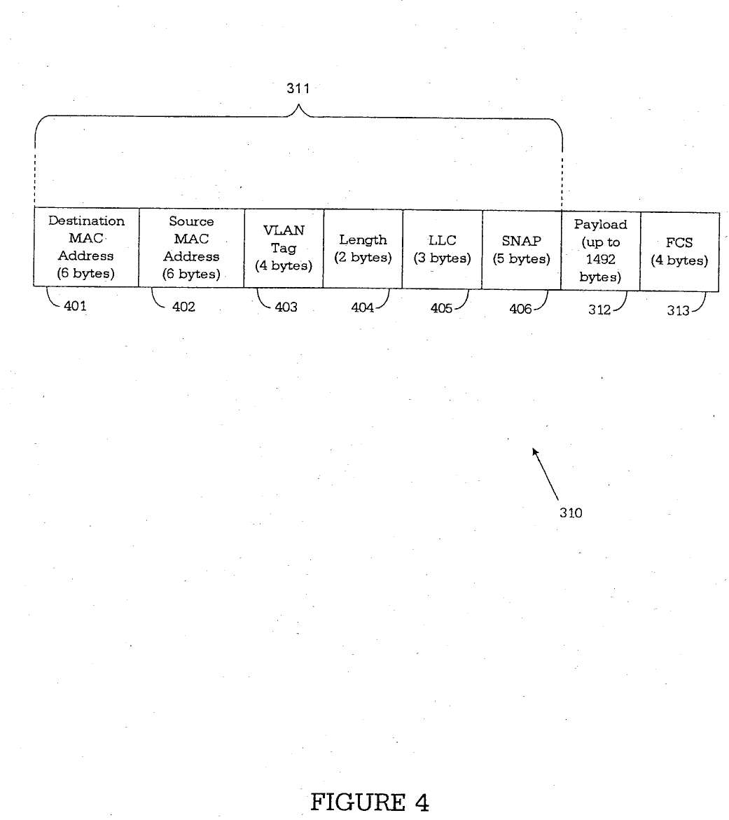

PMD module 122 initially receives Ethernet data frame 310 from external end-user device 380 (e.g., server, work station, other router, etc.). Data frame 310 comprises IEEE 802.3 sub-network access protocol (SNAP) header (with VLAN) 311, payload 312 and frame check sequence (FCS) 313. Exemplary payload 312 may contain up to 1492 bytes and exemplary frame check sequence 313 is a 4-byte field. FIG. 4 illustrates IEEE 802.3 SNAP header 311 in data frame 310 in greater detail according to an exemplary embodiment of the present invention. Exemplary SNAP header 311 comprises destination medium access control (MAC) address 401 (e.g., a 6-byte field), source MAC address 402 (e.g., a 6-byte field), VLAN tag 403 (e.g., a 4-byte field), length value 404 (e.g., a 2-byte field), LLC value 405 (e.g., a 3-byte field), and subnet access protocol (SNAP) value 406 (e.g., a 5-byte field). Destination MAC address 401 is the same as destination MAC address 302 in end-user device 390. Source MAC address 402 is the same as source MAC address 301 in end-user device 380.

Other forms of Ethernet framing are supported at the network interfaces 380 and 390, such as the Ethernet II framing encapsulating the packet in data frame 330. In this case the IEEE 802.3 SNAP header 311 is replaced in data frames 310, 320, 330, 340, and 350 by the Ethernet II header composed only of a destination address, source address, and length similar to 331, 332, and 333. Ethernet frames without VLAN are supported at access ports and at hybrid ports.

Data frame 310 may enter inbound PMD module 122 with VLAN tag 403 or VLAN tag 403 may added by PMD module 122. Initially, PMD processor 213a in PMD module 122 checks and then removes frame check sequence (FCS) 313. PMD processor 213a then adds interface descriptor (IFD) 321 and MPLS label 322, thereby forming data frame 320. Data frame 320 minus the IFD is the information frame that must be tunneled all the way through router 100 to outbound IOP module 136.

Inbound PMD module 122 transfers data frame 320 to inbound IOP module 126. Inbound IOP module 126 removes IFD 321 and adds new Ethernet framing comprising destination MAC address 331 (e.g., a 6-byte field), source MAC address 332 (e.g., a 6-byte field), length value 333 (e.g., a 2-byte field), and FCS 335. The FCS may be unnecessary, depending on the switch fabric requirements. The new Ethernet framing is necessary to transport the frame to outbound IOP module 136. Source MAC address 332 is associated with IOP module 126 and destination MAC address 331 is associated with IOP module 136.

Next, inbound IOP module 126 transfers data frame 330 to switch 150, which, in turn, transfers data frame 330 to outbound IOP module 136. Thus, at the interfaces between switch 150 and IOP modules 126 and 136, the following headers are present: Ethernet II for the switch/IOP module interface using the MAC addresses 331 and 332 of the outbound and inbound IOP modules as the destination and source MAC addresses, MPLS Label 322, and IEEE 802.3 SNAP header 311, which contains the source address 301 and destination address 302 of network devices 380 and 390, respectively.

Outbound PMD module 136 removes the outer Ethernet framing (i.e., destination MAC address 331, source MAC address 332 length value 333, and FCS 335) and adds IFD 321 to create data frame 340. Outbound IOP module 136 then sends data frame 340 to outbound PMD module 132. Outbound PMD module 132 removes IFD 321 and MPLS label 322 to form data frame 350 and transmits data frame 350 to end-user device 390. It is noted that outgoing data frame 350 is the same as incoming data frame 310. Optionally, VLAN tag 403 may be removed if distributed architecture router 100 is the VLAN termination point or it may be translated.

Although the present invention has been described with an exemplary embodiment, various changes and modifications may be suggested to one skilled in the art. It is intended that the present invention encompass such changes and modifications as fall within the scope of the appended claims.

What is claimed is:

1. For use in a communication network, a router capable of transmitting data frames to and receiving data frames from N peripheral devices, wherein said router is further capable of implementing a bridging function between a source peripheral device and a destination peripheral device, said router comprising:
a first physical medium device (PMD) module capable of receiving an inbound data frame from said source peripheral device; and
a second physical medium device (PMD) module capable of transmitting an outbound data frame to said destination peripheral device,
wherein said first PMD module identifies said second PMD module from a destination address in said inbound data frame and tunnels said inbound data frame through said router to said second PMD module.

2. The router as set forth in claim 1 wherein said second PMD module transmits said inbound data frame to said destination peripheral device as said outbound data frame.

3. The router as set forth in claim 2 wherein said first PMD module adds a VLAN tag to said inbound data frame prior to tunneling said inbound data frame and said VLAN tag to said second PMD module.

4. The router as set forth in claim 3 wherein said first PMD module tunnels said inbound data frame to said second PMD module by adding tunneling header information to said inbound data frame.

5. The router as set forth in claim 4 wherein said first PMD module is capable of determining if said inbound data frame is a non-IP frame and, in response to said determination, said first PMD module is further capable of adding an MPLS label to said tunneling header information.

6. The router as set forth in claim 5 wherein said router further comprises a first input-output processor (IOP) module and a second input-output processor (IOP) module, wherein said first IOP module is capable of receiving said inbound data frame and said tunneling header information from said first PMD module and replacing said tunneling header information with an Ethernet header suitable for transmitting said inbound data frame through an Ethernet switch to said second IOP module.

7. The router as set forth in claim 6 wherein said second IOP module is capable of replacing said Ethernet header with said tunneling header information from the forwarding descriptor in the forwarding table and transferring said inbound data frame and said tunneling header information to said second PMD module.

8. The router as set forth in claim 7 wherein said second PMD module receives said inbound data frame and said tunneling header information from said second IOP module, removes said tunneling header information, and transmits said inbound data frame to said second peripheral device as said outbound data frame.

9. A communication network comprising a plurality of routers capable of transmitting data frames to and receiving data frames from each other and from peripheral devices associated with said communication network, each one of said plurality of routers capable of implementing a bridging function between a source peripheral device and a destination peripheral device, said each router comprising:
a first physical medium device (PMD) module capable of receiving an inbound data frame from said source peripheral device; and
a second physical medium device (PMD) module capable of transmitting an outbound data frame to said destination peripheral device,
wherein said first PMD module identifies said second PMD module from a destination address in said inbound data frame and tunnels said inbound data frame through said router to said second PMD module.

10. The communication network as set forth in claim 9 wherein said second PMD module transmits said inbound data frame to said destination peripheral device as said outbound data frame.

11. The communication network as set forth in claim 10 wherein said first PMD module adds a VLAN tag to said inbound data frame prior to tunneling said inbound data frame and said VLAN tag to said second PMD module.

12. The communication network as set forth in claim 11 wherein said first PMD module tunnels said inbound data frame to said second PMD module by adding tunneling header information to said inbound data frame.

13. The communication network as set forth in claim 12 wherein said first PMD module is capable of determining if said inbound data frame is a non-IP frame and, in response to said determination, said first PMD module is further capable of adding an MPLS label to said tunneling header information.

14. The communication network as set forth in claim 13 wherein said router further comprises a first input-output processor (IOP) module and a second input-output processor (IOP) module, wherein said first IOP module is capable of receiving said inbound data frame and said tunneling header information from said first PMD module and replacing said tunneling header information with an Ethernet header suitable for transmitting said inbound data frame through an Ethernet switch to said second IOP module.

15. The communication network as set forth in claim 14 wherein said second IOP module is capable of replacing said Ethernet header with said tunneling header information from the forwarding descriptor in the forwarding table and transferring said inbound data frame and said tunneling header information to said second PMD module.

16. The communication network as set forth in claim 15 wherein said second PMD module receives said inbound data frame and said tunneling header information from said second TOP module, removes said tunneling header information, and transmits said inbound data frame to said second peripheral device as said outbound data frame.

17. For use in a router capable of transmitting data frames to and receiving data frames from N peripheral devices, a method of implementing in the router a bridging function between a source peripheral device and a destination peripheral device, the method comprising the steps of:
receiving in a first physical medium device (PMD) module an inbound data frame from the source peripheral device;
identifying in the first PMD module a second physical medium device (PMD) module associated with the destination peripheral device from a destination address in the inbound data frame;
tunneling the inbound data frame through the router to the second PMD module; and
transmitting from the second PMD module an outbound data frame to the destination peripheral device.

18. The method as set forth in claim 17 wherein the second PMD module transmits the inbound data frame to the destination peripheral device as the outbound data frame.

19. The method as set forth in claim 18 further comprising the step in the first PMD module of adding a VLAN tag to the inbound data frame prior to the step of tunneling the inbound data frame and the VLAN tag to the second PMD module.

20. The method as set forth in claim 19 wherein the step of tunneling the inbound data frame to the second PMD module comprises the sub-step of adding tunneling header information to the inbound data frame.

21. The method as set forth in claim 20 further comprising the steps of:
determining in the first PMD module if the inbound data frame is a non-IP frame; and
in response to a determination that the inbound data frame is a non-IP frame, adding an MPLS label to the tunneling header information.
